(19) United States
(12) Patent Application Publication
(10) Pub. No.: US 2011/0025884 A1
(43) Pub. Date: Feb. 3, 2011

(54) IMAGE PROCESSING APPARATUS, IMAGE MANAGEMENT APPARATUS, IMAGE MANAGEMENT METHOD, AND IMAGE MANAGEMENT SYSTEM

(75) Inventor: Masayoshi Tsunoda, Tokyo (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/835,370

(22) Filed: Jul. 13, 2010

(30) Foreign Application Priority Data
Jul. 29, 2009 (JP) 2009-177029

(51) Int. Cl. H04N 5/76

(52) U.S. Cl. 348/231.2; 348/E05.031

(57) ABSTRACT

An image processing apparatus, comprises a storage medium configured to store an image file; a communicating unit configured to communicate with an image management apparatus that manages an image file; a transmitting unit configured to transmit identification information of the image processing apparatus and a storage capacity of the storage medium to the image management apparatus; a receiving unit configured to receive identification information of the image management apparatus and a fixed reserved capacity via the communicating unit from the image management apparatus; and a first storage unit configured to store the identification information received from the image management apparatus and the fixed reserved capacity in association with each other.

### BACKGROUND OF THE INVENTION

1. Field of the Invention

The present invention relates to an image management technique for storing a captured image.

2. Description of the Related Art

Conventionally, images captured by capturing apparatuses such as digital cameras are stored and managed in storage media or the like of image management apparatuses such as computers. Some computers have a function of simultaneously communicating with a plurality of cameras. In this sort of situation, in the case where it is desired to simultaneously store images in a storage medium of a computer through communication with a plurality of cameras, the images may not be stored due to a shortage of capacity of the storage medium in the computer. In order to avoid this situation, there is a technique in which, when a connection is established between a camera and a computer or the like, a storage capacity is reserved so that at least one image file can be stored, and, when the connection is disconnected, the reservation of the storage capacity is cancelled (see Japanese Patent Laid-Open No. 2008-092543, for example).

Recently, as digital cameras that can easily capture images are becoming widely used, the number of users who have a plurality of cameras is increasing. In this sort of situation, a photo station has been attracting attention as an image management apparatus that stores and manages captured images. However, this photo station may not be able to store all captured images depending on the storage capacity of the photo station, for example, in the case where it is desired to simultaneously store captured images from a plurality of cameras.

### SUMMARY OF THE INVENTION

In order to solve the aforementioned problems, the present invention provides an image processing apparatus, comprising: a storage medium configured to store an image file; a communicating unit configured to communicate with an image management apparatus that manages an image file; a transmitting unit configured to transmit identification information of the image processing apparatus and a storage capacity of the storage medium to the image management apparatus; a receiving unit configured to receive identification information of the image management apparatus and a fixed reserved capacity via the communicating unit from the image management apparatus; and a first storage unit configured to store the identification information received from the image management apparatus and the fixed reserved capacity in association with each other.

The present invention also provides an image management apparatus, comprising: a first storage unit configured to store an image file; a communicating unit configured to communicate with an image processing apparatus that generates an image file; a receiving unit configured to receive, from the image processing apparatus, a capacity reservation request for securing in advance a storage capacity of the first storage unit so that an image file stored in the image processing apparatus can be stored in the first storage unit, and a storage capacity of the image processing apparatus; and a control unit configured to perform a control such that a storage area of the storage capacity received by the receiving unit is not used to store data received from an apparatus other than the image processing apparatus.

The present invention also provides an image management system in which an image processing apparatus that generates an image file and an image management apparatus that manages an image file communicate with each other, the image processing apparatus comprising: a storage medium configured to store an image file; a communicating unit configured to communicate with the image management apparatus that manages an image file; and a capacity reserving unit configured to transmit, to the image management apparatus, identification information of the image processing apparatus, a storage capacity of the storage medium, and a capacity reservation request for securing in advance a storage capacity of the image management apparatus so that an image file stored in the storage medium can be stored in the image management apparatus, and the image management apparatus comprising: a storage unit configured to store an image file; a communicating unit configured to communicate with the image processing apparatus that generates an image file; a receiving unit configured to receive, from the image processing apparatus, a capacity reservation request for securing in advance a storage capacity of the storage unit so that an image file stored in the image processing apparatus can be stored in the storage unit, and a storage capacity of the image processing apparatus; and a control unit configured to perform a control such that a storage area of the storage capacity received by the receiving unit is not used to store data received from an apparatus other than the image processing apparatus.

The present invention also provides an image management method of an image processing apparatus comprising a storage medium which stores an image file and a communication unit which communicates with an image management apparatus which manages an image file, the method comprising: a transmitting step of transmitting identification information of the image processing apparatus and a storage capacity of the storage medium to the image management apparatus; a receiving step of receiving identification information of the image management apparatus and a fixed reserved capacity via the communicating unit from the image management apparatus; and a storage step of storing the identification information received from the image management apparatus and the fixed reserved capacity in the storage medium in association with each other.

The present invention also provides an image management method of an image management apparatus comprising a storage medium which stores an image file and a communication unit which communicates with an image processing apparatus which generates an image file, the method comprising: a receiving step of receiving, from the image processing apparatus, a capacity reservation request for securing in advance a storage capacity of the storage medium so that an image file stored in the image processing apparatus can be stored in the storage medium, and a storage capacity of the image processing apparatus; and a control step of performing a control such that a storage area of the storage capacity received in the receiving step is not used to store data received from an apparatus other than the image processing apparatus.

According to the present invention, it is possible to reduce situations in which captured images that are to be stored cannot be stored due to a shortage of capacity, by reserving a storage capacity necessary for storing the captured images in an image management apparatus.

Further features of the present invention will become apparent from the following description of exemplary embodiments with reference to the attached drawings.

### BRIEF DESCRIPTION OF THE DRAWINGS

FIG. 1 is a diagram showing the configuration of an image management system of an embodiment according to the present invention.

FIG. 2A is a block diagram showing the configuration of an image processing apparatus.

FIG. 2B is an external view showing the configuration of the image processing apparatus.

FIG. 3 is a block diagram showing the configuration of an image management apparatus.

FIG. 4A is a diagram showing an example of a reservation table.

FIG. 4B is a diagram showing an example of a reservation management table.

FIG. 5 is a flowchart showing the operation of the image management system of this embodiment.

FIG. 6A is a flowchart showing a table generating process performed by the image processing apparatus in S53 of FIG. 5.

FIG. 6B is a flowchart showing a table generating process performed by the image management apparatus in S53 of FIG. 5.

FIG. 7A is a flowchart showing an image storing process in S55 of FIG. 5.

FIG. 7B is a view showing an example of a message displayed in S76 of FIG. 7A.

FIG. 8A is a flowchart showing a confirmation process of a possible storage capacity performed by the image processing apparatus in S71 of FIG. 7A.

FIG. 8B is a flowchart showing a confirmation process of a possible storage capacity performed by the image management apparatus in S71 of FIG. 7A.

FIG. 9A is a flowchart showing an ordinary storing process in S77 of FIG. 7A.

FIG. 9B is a view showing an example of a message displayed in S96 of FIG. 9A.

FIG. 10A is a flowchart showing a reservation updating process in S56 of FIG. 5.

FIG. 10B is a view showing an example of a message displayed when a reservation succeeds in S57 of FIG. 5.

FIG. 10C is a view showing an example of a message displayed when a reservation fails in S57 of FIG. 5.

### DESCRIPTION OF THE EMBODIMENTS

Embodiments of the present invention will be described in detail below with reference to the accompanying drawings.

The following embodiments are merely examples for practicing the present invention. The embodiments should be properly modified or changed depending on various conditions and the structure of an apparatus to which the present invention is applied. The present invention should not be limited to the following embodiments.

System Configuration

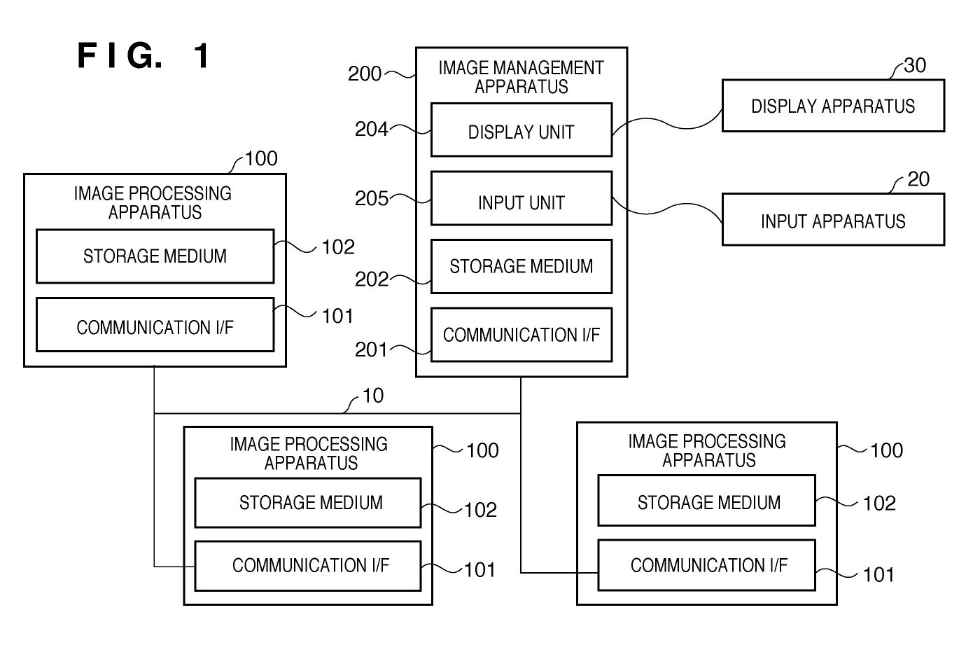

First, the configuration of an image management system of this embodiment will be described with reference to FIG. 1. In FIG. 1, numeral 100 denotes image processing apparatuses that generate image files, such as digital cameras, and numeral 200 denotes an image management apparatus that manages image files, such as a photo station. Numeral 10 denotes a communication line that can connect the plurality of image processing apparatuses 100 and the image management apparatus 200, and examples thereof include a USB, a LAN, and other special communication lines. Numeral 20 denotes an input apparatus such as a keyboard, a mouse, a touch panel, or the like, and the input apparatus is connected to the image management apparatus 200 such that any input can be given to the image management apparatus 200. Numeral 30 denotes a display apparatus that includes a liquid crystal panel, a plasma display, or the like, and that displays image data or video data output from the image management apparatus 200.

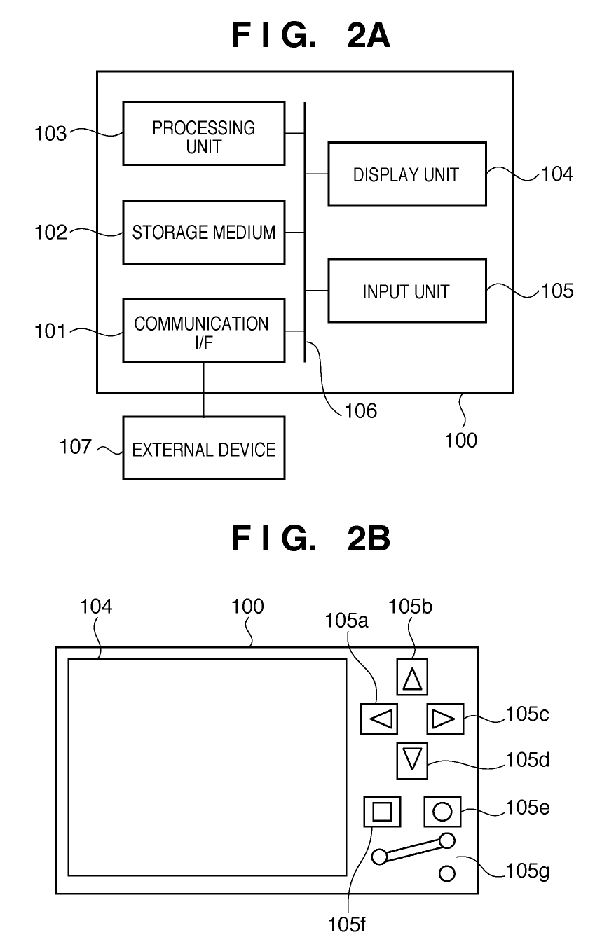

Next, the configuration of the image processing apparatus 100 of this embodiment will be described with reference to FIGS. 2A and 2B. In the image processing apparatus 100 in FIG. 2A, numeral 101 denotes a communication interface (I/F) that communicates with an external device 107 such as a computer. Numeral 102 denotes a storage medium such as a memory card, a hard disk, or the like, and the storage medium is built in or detachable from the apparatus. Numeral 103 denotes a processing unit that performs a control based on an operation instruction input from an input unit 105. Numeral 104 denotes a display unit that displays processing results or images stored in the storage medium 102. Numeral 105 denotes an input unit such as a keyboard, a mouse, or the like, wherein the input unit is built in or detachable from the image processing apparatus 100. Numeral 106 denotes a bus. The communication I/F 101, the storage medium 102, the processing unit 103, the display unit 104, and the input unit 105 mutually exchange data via the bus 106. A user inputs an operation instruction from the input unit 105 to the image processing apparatus 100, and the processing unit 103 performs a predetermined process according to the input operation.

In FIG. 2B, the image processing apparatus 100 has the display unit 104 and operation members 105a, 105b, 105c, 105d, 105e, 105f, and 105g that are connected to the input unit 105. The display unit 104 displays images, operation menu screens, or the like. The operation members 105a to 105d are up/down/left/right buttons that are operated, for example, when selected items on an operation menu are changed to the upper, lower, left, or right items. The operation member 105e is a mode setting button for changing a display mode of operation menu screen display, image display, and the like. The operation member 105f is a determination button for performing an item selected on an operation menu. The operation member 105g is a power switch for turning the image processing apparatus 100 on and off.

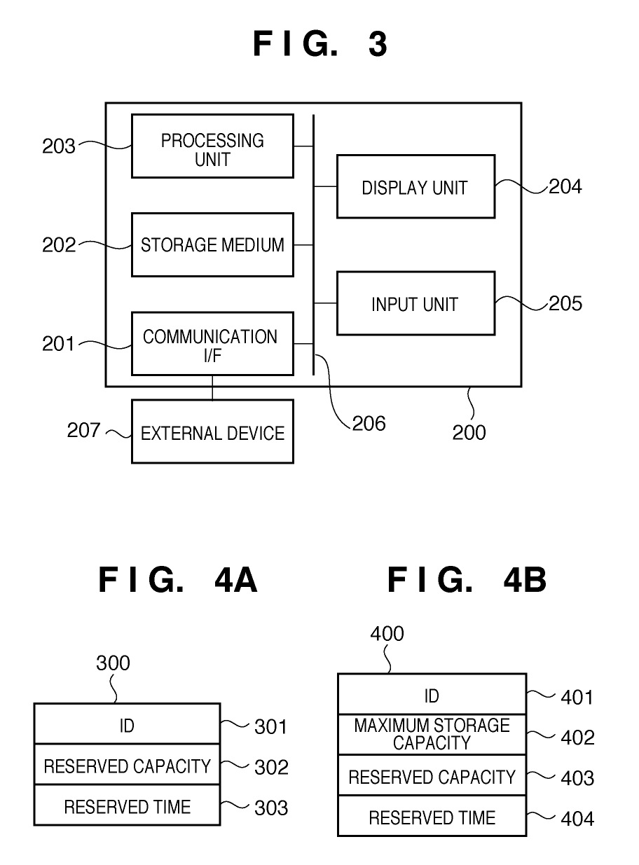

Next, the configuration of the image management apparatus 200 will be described with reference to FIG. 3. In the image management apparatus 200 in FIG. 3, numeral 201 denotes a communication I/F that communicates with an external device 207 such as a computer. Numeral 202 denotes a storage medium such as a memory card, a hard disk, or the like, wherein the storage medium is built in or detachable from the apparatus. Numeral 203 denotes a processing unit that performs a control based on an operation instruction input from an input unit 205. Numeral 204 denotes a display unit that is built in or detachable from the apparatus, and that displays processing results or images stored in the storage medium 202. Numeral 205 denotes an input unit that is built in or detachable from the apparatus, and examples thereof include a keyboard, a mouse, and the like. Numeral 206 denotes a bus. The communication I/F 201, the storage medium 202, the processing unit 203, the display unit 204, and the input unit 205 mutually exchange data via the bus 206. A user inputs an operation instruction from the input unit 205 to the image management apparatus 200, and the processing unit 203 performs a predetermined process according to the input operation.

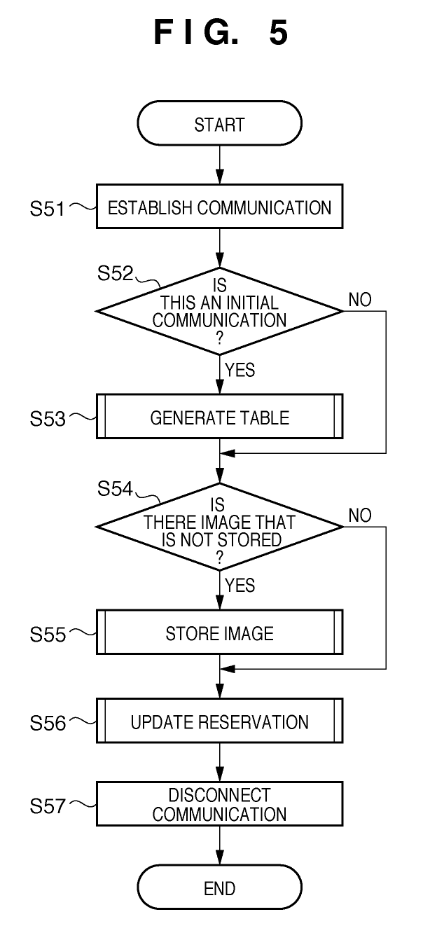

Next, a reservation table 300 managed by the image processing apparatus 100 will be described with reference to FIG. 4A. In FIG. 4A, numeral 301 denotes a unique ID (identification information) for uniquely identifying the image management apparatus 200. Numeral 302 denotes a reserved capacity of a reservation that has been fixed in the image management apparatus 200 identified by the ID 301. Numeral 303 denotes a time at which a reservation is updated in the image management apparatus 200 identified by the ID 301.

Next, a reservation management table 400 managed by the image management apparatus 200 will be described with reference to FIG. 4B. In FIG. 4B, numeral 401 denotes a unique ID (identification information) for uniquely identifying the image processing apparatus 100. Numeral 402 denotes a maximum storage capacity of a storage medium in the image processing apparatus 100 identified by the ID 401. Numeral 403 denotes a reserved capacity of a reservation that has been fixed from the image processing apparatus 100 identified by the ID 401. Numeral 404 denotes a time at which a reservation is updated from the image processing apparatus 100 identified by the ID 401.

Process Flow

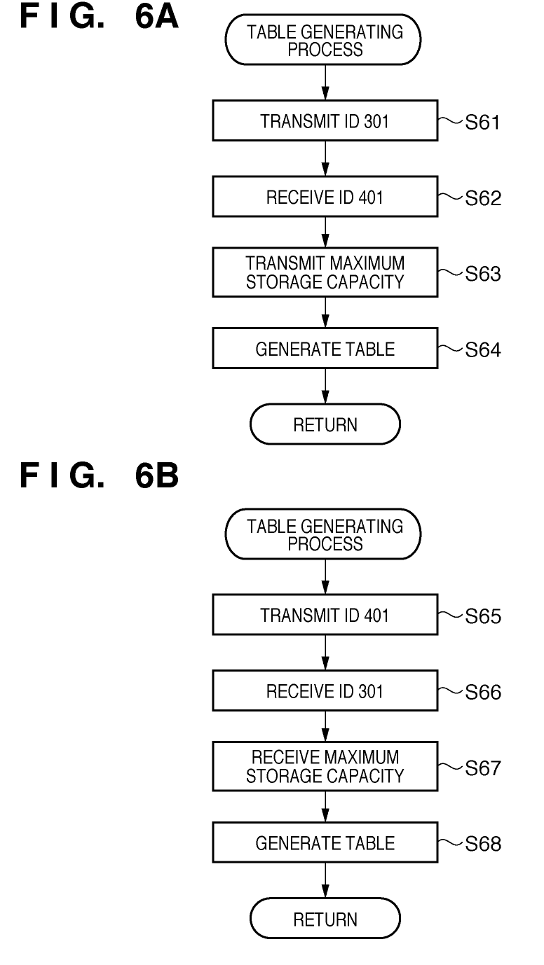

Hereinafter, the operation of the image management system of this embodiment will be described with reference to FIGS. 5 to 10.

Operation of Entire System

In FIG. 5, in S51, a communication is established between the image processing apparatus 100 and the image management apparatus 200 connected via the communication line 10. In S52, it is determined whether or not the communication established between the image processing apparatus 100 and the image management apparatus 200 is an initial communication. If the communication is an initial communication, the procedure advances to S53 where the image processing apparatus 100 and the image management apparatus 200 each perform a table generating process. If the communication is not an initial communication, the procedure advances to S54 where it is determined whether or not there is an image that is not stored, based on the table generated in S53. Then, if it is determined in S54 that there is an image that is not stored, the procedure advances to S55 where an image storing process is performed. On the other hand, if it is determined in S54 that there is no further image that is not stored, or after the image storing process in S55 is completed, the procedure advances to S56 where a process that determines whether or not to accept a reservation and a process that updates the reservation are performed, and then to S57 where the communication between the image processing apparatus 100 and the image management apparatus 200 is disconnected. Here, a result of the reservation fixed between the image processing apparatus 100 and the image management apparatus 200 is displayed on the display unit 104 of the image processing apparatus 100. Furthermore, the result may be displayed on the display unit 204 of the image management apparatus 200.

Table Generating Process

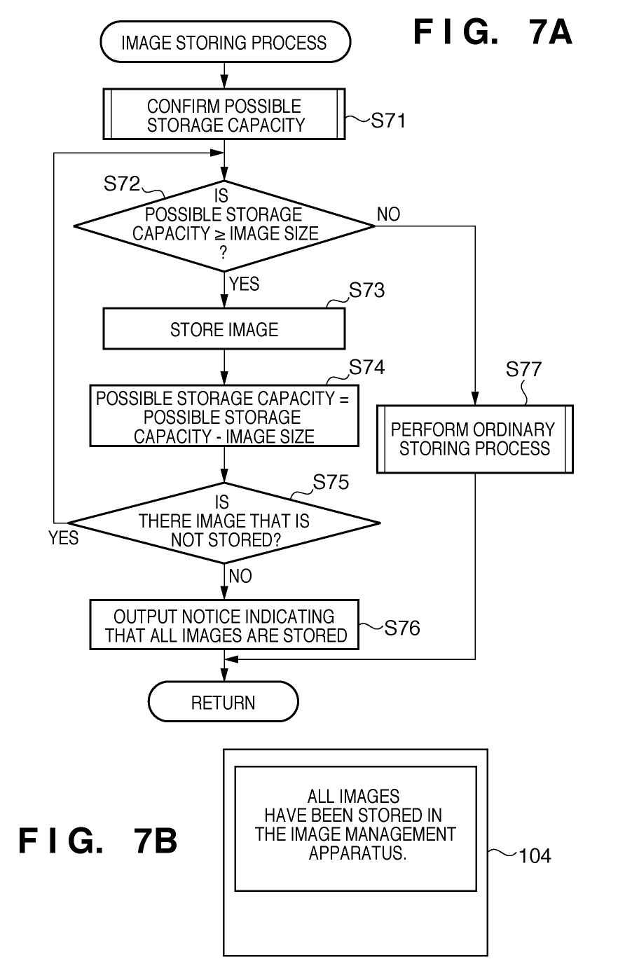

Next, the table generating process performed by the image processing apparatus 100 in S53 of FIG. 5 will be described with reference to FIG. 6A. In FIG. 6A, in S61, the ID 401 for identifying the image processing apparatus 100 is transmitted to the image management apparatus 200. In S62, the ID 301 for identifying the image management apparatus 200 is received from the image management apparatus 200. In S63, the maximum storage capacity of the storage medium in the image processing apparatus 100 is transmitted to the image management apparatus 200. In S64, the reservation table 300 is generated in which the reservation time 303 is a time at which the ID 301 is received in S62 and the reserved capacity is 0. Here, the reservation time 303 may be a time at which a communication is established.

Next, the table generating process performed by the image management apparatus 200 in S53 of FIG. 5 will be described with reference to FIG. 6B. In FIG. 6B, in S65, the ID 301 for identifying the image management apparatus 200 is transmitted to the image processing apparatus 100. In S66, the ID 401 for identifying the image processing apparatus 100 is received from the image processing apparatus 100. In S67, the maximum storage capacity of the storage medium in the image processing apparatus 100 is received and taken as the maximum storage capacity 402. In S68, the reservation management table 400 is generated in which the reservation time 404 is a time at which the ID 401 is received in S66 and the reserved capacity is 0. Here, the reservation time 404 may be a time at which a communication is established.

Image Storing Process

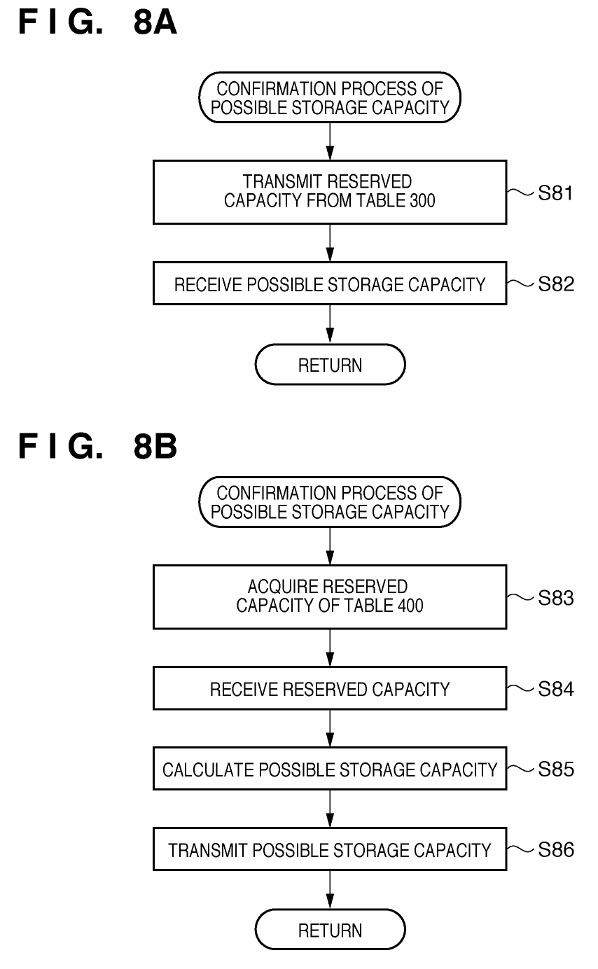

Next, the image storing process performed by the image processing apparatus 100 and the image management apparatus 200 in S55 of FIG. 5 will be described with reference to FIGS. 7A and 7B. In FIG. 7A, in S71, the image processing apparatus 100 and the image management apparatus 200 each confirm a possible storage capacity. In S72, it is determined whether or not the possible storage capacity confirmed in S71 is at least the size of an image that is to be stored next. Then, if the possible storage capacity is at least the image size, the procedure advances to S73 where the image is stored in the image management apparatus 200. Subsequently, in S74, a value obtained by subtracting the size of the image stored in the image management apparatus 200 from the possible storage capacity is updated as a new possible storage capacity. Then, in S75, if there is an image file that is not stored, the procedure returns to S72, and, if there is no further image file that is not stored, the procedure advances to S76 where a message indicating that all image files are stored is displayed. Here, as shown in FIG. 7B, the message “all images have been stored in the image management apparatus” is displayed at the center of the display unit 104 of the image processing apparatus 100. This message may be deleted after a predetermined time has elapsed, or may be deleted by operating the operation member 105f. Here, the display or the notice in FIG. 7B may be output to one or both of the image processing apparatus 100 and the image management apparatus 200. On the other hand, if it is determined in S72 that the possible storage capacity is smaller than the image size, the procedure advances to S77 where an ordinary storing process that stores the image in a storage area that is not reserved is performed.

In the image storing process, the processing unit 203 of the image management apparatus 200 performs a control such that a storage area according to the maximum storage capacity received from the image processing apparatus 100 is not used to store data received from an apparatus other than the image processing apparatus 100.

Confirmation Process of Possible Storage Capacity

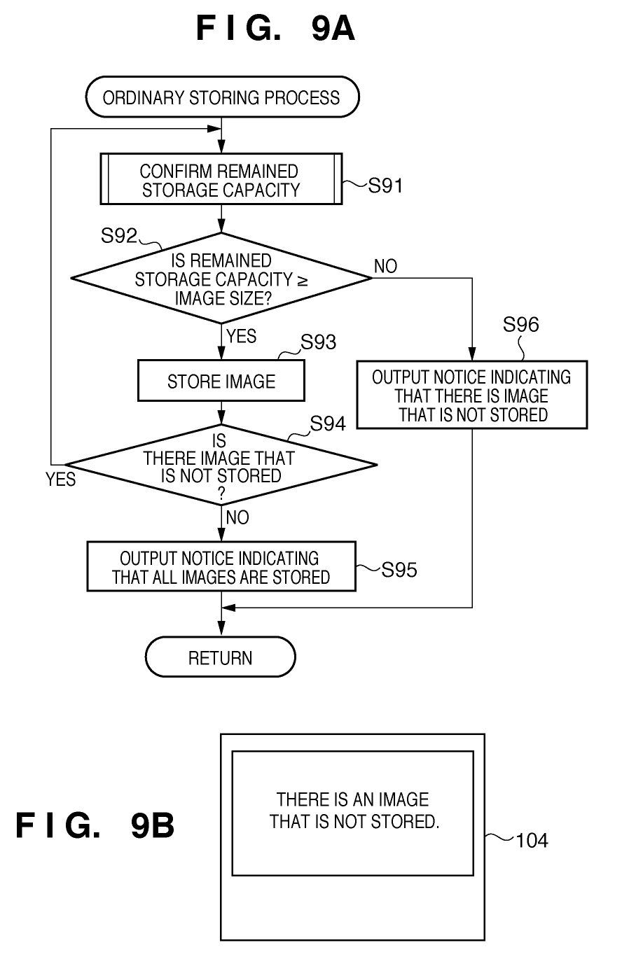

Next, the confirmation process of a possible storage capacity performed by the image processing apparatus 100 in S71 of FIG. 7A will be described with reference to FIG. 8A. In FIG. 8A, in S81, the reserved capacity 302 is acquired from the reservation table 300 using the ID 301 of the connected image management apparatus 200, and transmitted to the image management apparatus 200. Subsequently, in S82, the possible storage capacity calculated by the image management apparatus 200 is received.

Next, the confirmation process of a possible storage capacity performed by the image management apparatus 200 in S71 of FIG. 7A will be described with reference to FIG. 8B. In FIG. 8B, in S83, the reserved capacity 403 is acquired from the reservation management table 400 using the ID 401 of the connected image processing apparatus 100. In S84, the reserved capacity 302 registered in the reservation table 300 of the image processing apparatus 100 is received. In S85, the reserved capacity 403 and the reserved capacity 302 are compared, and the smaller value is calculated as the possible storage capacity. Here, for example, the larger value of the reserved capacity 403 and the reserved capacity 302 may be taken as the possible storage capacity, or the larger value or the smaller value may be selected as the possible storage capacity according to the reservation time 404 and the elapsed time. In S86, the possible storage capacity calculated in S85 is transmitted to the image processing apparatus 100.

Ordinary Storing Process

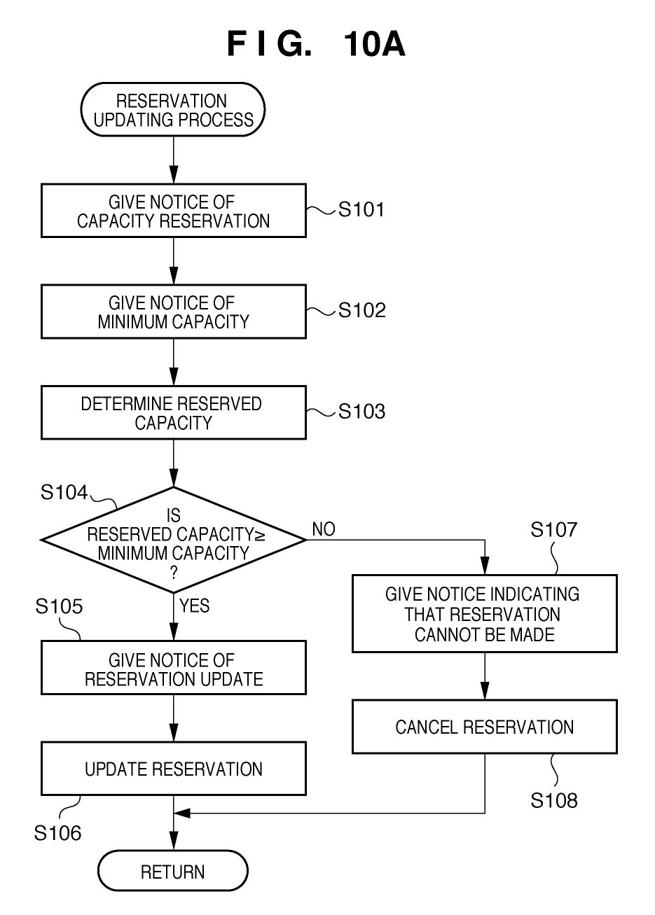

Next, the ordinary storing process performed by the image processing apparatus and the image management apparatus in S77 of FIG. 7A will be described with reference to FIGS. 9A and 9B. In FIG. 9A, in S91, the image processing apparatus 100 and the image management apparatus 200 each confirm a remaining storage capacity. In S92, it is determined whether or not the remaining storage capacity acquired in S91 is at least the size of an image that is to be stored next. Then, if the remaining storage capacity is at least the image size, the procedure advances to S93 where the image is stored in the image management apparatus 200. Then, in S94, it is determined whether or not there is an image that is not stored, and, if there is an image that is not stored, the procedure returns to S91, and, if there is no further image that is not stored, the procedure advances to S95 where a message indicating that all images are stored is displayed on the display unit 104 of the image processing apparatus 100. Here, the notice indicating that all images are stored may be output to one or both of the image processing apparatus 100 and the image management apparatus 200.

On the other hand, if it is determined in S92 that the possible storage capacity is smaller than the image size, the procedure advances to S96 where a message indicating that there is an image that is not stored is displayed on the display unit 104 of the image processing apparatus 100. Here, as shown in FIG. 9B, the message “there is an image that is not stored” is displayed at the center of the display unit 104 of the image processing apparatus 100. This notice indicating that there is an image that is not stored may be output to one or both of the image processing apparatus 100 and the image management apparatus 200. Furthermore, in the case where a notice indicating that there is an image that is not stored is received, the image management apparatus 200 may, for example, display a message for urging a reduction in images stored in the storage medium 202, and automatically compress or delete images in the storage medium, thereby reducing the number of images.

Reservation Updating Process

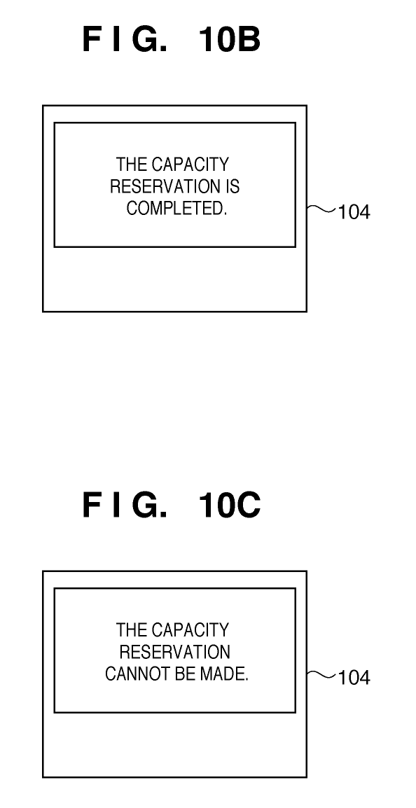

Next, the reservation updating process performed by the image processing apparatus and the image management apparatus in S56 of FIG. 5 will be described with reference to FIGS. 10A to 10C. In FIG. 10A, in S101, a capacity reservation request for securing a storage area is given from the image processing apparatus 100 to the image management apparatus 200. It is assumed that the requested capacity is the maximum storage capacity of the storage medium 102 in the image processing apparatus 100. Here, the requested capacity may be a value freely input by the user, or may be an available capacity of the storage medium 102. In S102, the image processing apparatus 100 notifies the image management apparatus 200 of half the available capacity of the storage medium 102 as a minimum required capacity of the image processing apparatus 100. Furthermore, this minimum required capacity may be set using, as a reference, the maximum size or the minimum size of an image that can be captured by the image processing apparatus 100. In S103, the image management apparatus 200 determines the reserved capacity of the image processing apparatus 100. In the case where the available capacity of the storage medium 202 in the image management apparatus 200 is larger than the requested capacity received from the image processing apparatus 100 in S101, the above-described reserved capacity is set to the received requested capacity. Furthermore, in the case where the available capacity of the storage medium 202 is smaller than the requested capacity and the minimum required capacity or larger, the reserved capacity is set to the available capacity of the storage medium 202, and, if the available capacity of the storage medium 202 is smaller than the minimum required capacity, the reserved capacity is set to 0.

In S104, it is determined whether or not the reserved capacity is the minimum required capacity or larger in the image management apparatus 200. If it is determined in S104 that the reserved capacity is the minimum required capacity or larger, the procedure advances to S105 where the image management apparatus 200 notifies the image processing apparatus 100 of reservation update. This notice of reservation update is given by transmitting, to the image processing apparatus 100, the time at which the reserved capacity was determined in S103. Then, in S106, the image processing apparatus 100 and the image management apparatus 200 respectively update the reservation table 300 and the reservation management table 400 using the reserved capacity and the reserved capacity determined time. On the other hand, if it is determined in S104 that the reserved capacity is smaller than the minimum required capacity, the procedure advances to S107 where the image management apparatus 200 notifies the image processing apparatus 100 that the reservation cannot be made. This notice indicating that the reservation cannot be made is given by transmitting, to the image processing apparatus 100, the reserved capacity determined time and the reserved capacity 0. Then, in S108, the image processing apparatus 100 and the image management apparatus 200 respectively cancel the reservation table 300 and the reservation management table 400 using the reserved capacity and the reserved capacity determined time.

If the reservation succeeds and the communication is disconnected in S57 of FIG. 5, the message “the capacity reservation is completed” is displayed at the center of the display unit 104 of the image processing apparatus 100 as shown in FIG. 10B. Furthermore, the reserved capacity may be displayed as a numerical value, or the ID 301 of the image management apparatus 200 in which the reservation has been made may be displayed. Furthermore, if the reservation fails and the communication is disconnected in S57 of FIG. 5, the message “the capacity reservation cannot be made” is displayed at the center of the display unit 104 of the image processing apparatus 100 as shown in FIG. 10C.

According to the foregoing embodiment, the image processing apparatus 100 reserves a storage capacity necessary for storing captured images in the image management apparatus 200, and, thus, situations can be reduced in which captured images that are to be stored cannot be stored due to a shortage of capacity.

Furthermore, in the foregoing embodiment, an example was described in which a reservation request is made from a camera (the image processing apparatus 100) to a home server (the image management apparatus 200), but a modified example is possible in which the home server starts a reservation control, and gives a transmission request to the camera, the camera accordingly transmits the capacity of a memory card (the storage medium 102), and the home server stores the ID of the camera and the capacity of the memory, makes a reservation such that a storage capacity corresponding to that capacity does not store data received from an apparatus other than that camera, and transmits, to the camera, the reserved capacity and the apparatus ID.

In another embodiment, the image management apparatus 200 may request a reservation operation to the image processing apparatus and the image processing apparatus 100 may transmit a required storage capacity and ID 401 of the image processing apparatus based on the request of the image management apparatus. Further, the image management apparatus 200 may store the required storage capacity and ID 401 of the image processing apparatus and reserve the required storage capacity so as not to store data received from the image processing apparatus 100 other than the image processing apparatus that is identified with ID 401. The image management apparatus 200 may transmit the reserved storage capacity and ID 301 of the image management apparatus to the image processing apparatus 100.

### Other Embodiments

Aspects of the present invention can also be realized by a computer of a system or apparatus (or devices such as a CPU or MPU) that reads out and executes a program recorded on a memory device to perform the functions of the above-described embodiment, and by a method, the steps of which are performed by a computer of a system or apparatus by, for example, reading out and executing a program recorded on a memory device to perform the functions of the above-described embodiment. For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-177029, filed Jul. 29, 2009 which is hereby incorporated by reference herein in its entirety.

What is claimed is:

1. An image processing apparatus, comprising:
a storage medium configured to store an image file;
a communicating unit configured to communicate with an image management apparatus that manages an image file;
a transmitting unit configured to transmit identification information of the image processing apparatus and a storage capacity of the storage medium to the image management apparatus;
a receiving unit configured to receive identification information of the image management apparatus and a fixed reserved capacity via the communicating unit from the image management apparatus; and
a first storage unit configured to store the identification information received from the image management apparatus and the fixed reserved capacity in association with each other.

2. The apparatus according to claim 1, wherein the transmitting unit transmits, to the image management apparatus, a capacity reservation request for securing in advance a storage capacity of the image management apparatus so that an image file stored in the storage medium can be stored in the image management apparatus.

3. The apparatus according to claim 2, further comprising:
a second storage unit configured to acquire a possible storage capacity calculated by the image management apparatus, and to store an image file in the image management apparatus based on the possible storage capacity; and
an updating unit configured to update a reservation table based on the size of the image file stored in the image management apparatus.

4. The apparatus according to claim 3, wherein, in a case where the possible storage capacity is smaller than the size of an image file that is not stored, the second storage unit stores the image file that is not stored, in a storage area that is not reserved in the image management apparatus.

5. An image management apparatus, comprising:
a first storage unit configured to store an image file;
a communicating unit configured to communicate with an image processing apparatus that generates an image file;
a receiving unit configured to receive, from the image processing apparatus, a capacity reservation request for securing in advance a storage capacity of the first storage unit so that an image file stored in the image processing apparatus can be stored in the first storage unit, and a storage capacity of the image processing apparatus; and
a control unit configured to perform a control such that a storage area of the storage capacity received by the receiving unit is not used to store data received from an apparatus other than the image processing apparatus.

6. The apparatus according to claim 5, further comprising:
a first determination unit configured to determine a reserved capacity based on a storage capacity of an available area in the first storage unit and a storage capacity according to the capacity reservation request;
a second determination unit configured to determine whether or not to accept a reservation based on the reserved capacity determined by the first determination unit and a minimum storage capacity necessary for storing the image file; and
a notifying unit configured to give notice of a result of the determination by the second determination unit.

7. The apparatus according to claim 6, further comprising:
a receiving unit configured to receive identification information and a maximum storage capacity of the image processing apparatus via the communicating unit from the image processing apparatus, and the reserved capacity determined by the first determination unit; and
a generating unit configured to generate a reservation management table containing the identification information and the maximum storage capacity of the image processing apparatus received therefrom, and the determined reserved capacity.

8. The apparatus according to claim 7, further comprising:
a calculating unit configured to calculate a possible storage capacity of the storage medium based on a reserved capacity received from the image processing apparatus and a reserved capacity registered in the reservation management table; and
a transmitting unit configured to transmit the calculated possible storage capacity to the image processing apparatus.

9. The apparatus according to claim 8, further comprising:
a second storage unit configured to store an image file that is not stored in a storage area that is not reserved in the image management apparatus, in a case where the calculated possible storage capacity is smaller than the size of the image file that is not stored.

10. An image management system in which an image processing apparatus that generates an image file and an image management apparatus that manages an image file communicate with each other,
the image processing apparatus comprising:
a storage medium configured to store an image file;
a communicating unit configured to communicate with the image management apparatus that manages an image file; and
a capacity reserving unit configured to transmit, to the image management apparatus,
identification information of the image processing apparatus, a storage capacity of the storage medium, and a capacity reservation request for securing in advance a storage capacity of the image management apparatus so that an image file stored in the storage medium can be stored in the image management apparatus, and
the image management apparatus comprising:
a storage unit configured to store an image file;
a communicating unit configured to communicate with the image processing apparatus that generates an image file;
a receiving unit configured to receive, from the image processing apparatus, a capacity reservation request for securing in advance a storage capacity of the storage unit so that an image file stored in the image processing apparatus can be stored in the storage unit, and a storage capacity of the image processing apparatus; and
a control unit configured to perform a control such that a storage area of the storage capacity received by the receiving unit is not used to store data received from an apparatus other than the image processing apparatus.

11. An image management method of an image processing apparatus comprising a storage medium which stores an image file and a communication unit which communicates with an image management apparatus which manages an image file, the method comprising:
a transmitting step of transmitting identification information of the image processing apparatus and a storage capacity of the storage medium to the image management apparatus;
a receiving step of receiving identification information of the image management apparatus and a fixed reserved capacity via the communicating unit from the image management apparatus; and
a storage step of storing the identification information received from the image management apparatus and the fixed reserved capacity in the storage medium in association with each other.

12. An image management method of an image management apparatus comprising a storage medium which stores an image file and a communication unit which communicates with an image processing apparatus which generates an image file, the method comprising:
a receiving step of receiving, from the image processing apparatus, a capacity reservation request for securing in advance a storage capacity of the storage medium so that an image file stored in the image processing apparatus can be stored in the storage medium, and a storage capacity of the image processing apparatus; and
a control step of performing a control such that a storage area of the storage capacity received in the receiving step is not used to store data received from an apparatus other than the image processing apparatus.

13. A computer-readable storage medium with an executable program stored thereon, wherein the program instructs a microprocessor to perform the method according to claim 11.

14. A computer-readable storage medium with an executable program stored thereon, wherein the program instructs a microprocessor to perform the method according to claim 12.
